(19) United States
(12) Patent Application Publication
(10) Pub. No.: US 2024/0304787 A1
(43) Pub. Date: Sep. 12, 2024

(54) METHOD FOR PREPARING AN ELECTRODE WITH HIGH LOAD PER UNIT OF MASS FILLED WITH ELECTROLYTE FOR A BATTERY WITH HIGH ENERGY DENSITY

(71) Applicant: Solvionic, Toulouse (FR)

(72) Inventors: Rongying Lin, Toulouse (FR); Anaïs Falgayrat, Toulouse (FR)

(21) Appl. No.: 18/258,460

(22) PCT Filed: Dec. 23, 2021
(86) PCT No.: PCT/FR2021/052450

§ 371 Date: Jun. 20, 2023

(30) Foreign Application Priority Data
Dec. 24, 2020 (FR) FR2014133

(51) Int. Cl. H01M 4/1391; H01M 4/04; H01M 4/505; H01M 4/525; H01M 4/58; H01M 4/62; H01M 10/0525; H01M 10/054; H01M 10/0565

(52) U.S. Cl. CPC H01M 4/1391; H01M 4/0435; H01M 4/505; H01M 4/525; H01M 4/5825; H01M 4/623; H01M 10/0525; H01M 10/054; H01M 10/0565; H01M 2300/0085

(57) ABSTRACT

A method is used for preparing batteries with high energy density. More particularly, the method is used for preparing an electrode with high load energy-density metal-ion-based battery. This method comprises preparing an electrolyte-filled solid electrode by mixing a salt, a solvent, a binder, and an active material to produce a mechanically stable paste.

### CROSS-REFERENCE TO RELATED APPLICATIONS

This application is a national phase entry under 35 U.S.C. § 371 of International Patent Application PCT/FR2021/052450, filed Dec. 23, 2021, designating the United States of America and published as International Patent Publication WO 2022/136810 A1 on Jun. 30, 2022, which claims the benefit under Article 8 of the Patent Cooperation Treaty to French Patent Application Serial No. FR2014133, filed Dec. 24, 2020.

### TECHNICAL FIELD

The present disclosure relates to a method for preparing high energy-density electrochemical batteries. The present disclosure relates more particularly to an improved method for preparing a high charge per unit mass electrode for a metal-ion-based high energy-density battery. This method comprises the preparation of a solid electrolyte-filled electrode by mixing a salt, a solvent, a binder and an active material to produce a paste.

### BACKGROUND

The charge storage in the electrochemical battery is based on Faraday reactions that occur simultaneously at the negative electrode (reduction of the anode material and oxidation of the electrolyte components) and at the positive electrode (oxidation of the cathode material and reduction of the electrolytic components) when charging the battery. By virtue of these oxidation-reduction reactions, a battery is charged by conversion of external electrical energy into chemical energy. Electrons from an external power source move towards the anode and, on the other side of the external circuit, electrons are removed from the cathode. Conversely, a battery is discharged by conversion of chemical energy into electrical energy to power an external electrical system. The active materials of the cathode are generally metal-based oxides consisting of critical metals such as nickel, cobalt and lithium. Other typical metals that play an important role in the battery production line are aluminum, manganese, copper, magnesium and iron. The active materials for anodes are generally composites containing graphite, with high and low silicon content with carbonaceous materials, metal oxides or metals such as lithium and sodium. The electrolyte plays an important role in the transport of ions between the anodes and cathodes. In addition, filling the electrolyte in the tightly wound battery device is difficult when the electrode thickness increases or for example when ionic liquids (slightly more viscous than organic-based electrolytes) are used. This electrolyte filling step generally takes place after the assembly of the electrochemical cell and may take time; the filling time increases with the viscosity of the electrolyte.

Current electrolyte technology uses solvents that are flammable and have a high vapor pressure. This leads to accumulation of high pressure in the apparatus in the event of temperature variations or high temperature.

The prior art describes various methods for producing electrochemical batteries. For example, U.S. Pat. No. 10,276,856 describes a method comprising a solvent evaporation step.

In contrast, EP 3,444,869 describes a dry production method for an electrode for a lithium secondary battery comprising the steps consisting of:
(S1) dry mixing a conducting material and an electrode active material;
(S2) dry mixing the product resulting from step (S1) with a binder to obtain an electrode mixture powder; and
(S3) applying the electrode mixture powder to at least one surface of a current collector.

Furthermore, in order to improve the energy density of the battery, the thickness of the electrode must be optimized. The methods for preparing an electrode of this type of prior art require a support for controlling the thickness of the electrode, for example as described in U.S. Pat. No. 10,361,460.

In addition, the current technology for preparing electrodes uses solvents that are flammable and have a high vapor pressure. This requires a high-temperature drying process. When the thickness increases, the evaporation rate of the solvent becomes a restrictive parameter that induces a risk of cracking of the electrode.

For these reasons, the methods of the prior art are not compatible with production on an industrial scale.

There is a need for a method for preparing a high energy-density battery that is applicable to the industrial level.

### BRIEF SUMMARY

A new method for manufacturing electrodes intended for high energy-density batteries has been implemented. This method involves preparing an electrolyte-filled high charge per unit mass electrode for a high energy-density battery by following the steps consisting of:
a) preparing a mixture A comprising the electrolyte by mixing a metal salt with a solvent;
b) mixing the mixture A with an active material to obtain a paste;
a binder being added at one of steps a) or b);
c) forming the electrode with a predetermined thickness.

The present disclosure also relates to an apparatus for implementing the method, as well as the electrolyte-filled high charge per unit mass electrode obtained by the method and the high energy-density battery comprising the electrode.

The present disclosure proposes a new type of high energy-density battery comprising an electrolyte-filled high charge per unit mass electrode prepared using an innovative method. This method makes it possible to control the thickness of the electrode, which makes it possible to increase the energy density of the battery since the two parameters are correlated; in fact, the thicker the electrode, the more energy the battery contains.

The method according to the present disclosure has several advantages.

Firstly, the electrode is prepared without needing a support to obtain the desired thickness. The thickness of the electrode is controlled during the method based on the fact that the material of the electrode has the consistency of a paste having a mechanical strength. In the prior art preparation methods, the paste must be coated on current collectors before being supplied, for the “roll-to-roll” type assembly, in battery production lines. In this disclosure, the mechanically stable and electrolyte-filled electrode can be directly calendered without support and can be implemented easily in assembly lines of “roll-to-roll” batteries.

Secondly, the electrode components are kneaded with the electrolyte to form a paste that makes it possible to optimize the cohesion between the active material and the electrolyte. This conformation allows close contact and immediate proximity between the surface of the electrode material and the electrolyte ions. Generally, the thickness of conventional electrodes is limited to 100 μm, not only due to the unstable behavior of the electrode and to the low adhesion to the current collector, but also to the poor kinetics caused by the inhomogeneity, and long and tortuous ion/electronic diffusion paths in the thick film. This disclosure makes it possible both to reduce the serial resistance of the electrode/electrolyte interface and to increase the kinetics and the accessibility of the electrolyte to the electrode particles such that the power of the battery is optimized. The mixture of electrolyte and electrode materials improves kinetics by directly bringing the electrolyte ions near the surface of the active material particles, reducing the time required for the diffusion of electrolytes in the electrode mass compared to the prior art method for dry electrode preparation. By reducing the diffusion time and increasing the homogeneity of the electrolyte distribution throughout the entire volume of the electrode, the power delivered can be improved.

Thirdly, this method makes it possible to prepare a new generation of high energy-density batteries.

A wide range of products can thus be prepared using the principles of the electrolyte-filled electrode, by combining different types of components such as solvent, salt, binder and active material depending on the battery needs.

Fourthly, the method as a whole is simplified with a reduced number of steps compared to the prior art methods (no solvent evaporation, no support need).

Fifthly, the method eliminates the tedious step of optimizing the paste and coating using the latter. In the prior art methods, the electrode pastes must be optimized from the point of view of their rheological properties in order to obtain a good interaction surface, in order to obtain calendering to a desired porosity. Such an optimization must be carried out for each different type of active material, electrode components and method medium (aqueous or organic solvents). In addition, differential capillarity in the electrodes must be absorbed during the drying step in order to minimize the cracks. The preparation of the paste is important and it is necessary to control its viscosity and its resistance to sedimentation, which may both negatively affect the physical and electrochemical properties of an electrode. The viscosity of the paste directly affects the coating process. Materials that flow too quickly tend to disperse during coating, resulting in a coating layer that is not uniform, while materials that are too viscous will take longer for coating, to dry and may reduce efficiency at pressure under vacuum.

The viscosity of a paste depends on the ratio between the solid material and the solvent. For the sake of protecting the environment, it is important to maximize the solid content and to reduce the solvent content. There are two methods for preparing pastes, 1) using an organic solvent such as N-methyl-2-pyrrolidone (NMP), which is a hazardous chemical, and 2) using water as solvent, which requires intense efforts to adjust the pH of the pastes for the stability of the electrode materials. The viscosity of the paste may also be adjusted by varying the temperature. In this disclosure, the solvent in the mixing medium is the electrolyte and, consequently, it is not necessary to optimize the viscosity of the paste, the pH or temperature values since the method can be carried out at room temperature due to the fact that there is no organic solvent.

It is possible to add an additive to the electrolyte so as to further improve the capacity of the battery.

In addition, the preparation of a high energy-density battery comprising an electrode according to the present disclosure is advantageous on the industrial level due to the fact that the electrolyte is already in the electrode; the step of adding the electrolyte after assembly of the battery is therefore avoided.

Based on the advantages described above, the method is quite versatile and can be easily implemented at the industrial level.

### BRIEF DESCRIPTION OF THE DRAWINGS

FIG. 1: Representation of steps a and b of the method for preparing the paste for the electrolyte-filled electrode material.

FIG. 2: Representation of step c of the method for preparing the paste at a desired thickness of the electrolyte-filled electrode.

FIG. 3: Schematic view of the method for preparing an electrolyte-filled electrode according to the present disclosure.

FIG. 4: Representation of the different layers of a button battery: (1) represents the current collector (1A) and the electrolyte-filled cathode (1B) and (2) represents the current collector (2A) and the electrolyte-filled anode (2B); A represents the current collectors and B represents electrolyte-filled electrodes. (3) represents the separator.

FIG. 5: Graph showing the half battery (LFP//Li metal) charge/discharge profiles at a C rate of 0.05 C of 2.5 V to 4.0 V with respect to Li⁺/Li at 40° C. The electrolyte-filled LFP cathode was prepared using the method from this disclosure.

FIG. 6: Graph showing charge/discharge profiles of two batteries (LMNO//Graphite) at C rate of C/20 (0.05 C) from 2.0 V to 5.0 V vs. Li⁺/Li at 20° C. The electrolyte-filled 107 μm and 173 μm thickness LMNO cathodes were prepared using the method from this disclosure and the anode is commercial.

FIG. 7: Graph showing battery (LMNO//Graphite) charge/discharge profiles at C rate of C/20 (0.05 C) and C/10 (0.1 C) from 2.0 V to 5.0 V compared to Li⁺/Li at 20° C. The electrolyte-filled 132 μm thickness LMNO cathode was prepared using the method from this disclosure and the anode is commercial.

FIG. 8: Graph showing battery (LMNO//Graphite) charge/discharge profiles at C rate of C/20 (0.05 C) and C/10 (0.1 C) from 2.0 V to 5.0 V compared to Li⁺/Li at 20° C. The electrolyte-filled 179 μm thickness LMNO cathode was prepared using the method from this disclosure and the anode is commercial.

FIG. 9: Graph showing battery (LMNO//Graphite) charge/discharge profiles at C rate of C/20 (0.05 C) from 2.0 V to 5.0 V compared to Li⁺/Li at 20° C. The electrolyte-filled LMNO cathode was prepared using the method from this disclosure and the anode is commercial.

FIG. 10: Graph showing charge/discharge profiles of two batteries (LMNO//Graphite) at C rate of C/20 (0.05 C) from 2.0 V to 5.0 V compared to Li⁺/Li at 20° C. The LMNO cathodes filled with two different electrolytes were prepared using the method from this disclosure. The anodes are commercial.

FIGS. 11A and 11B: Impedance spectroscopy from 1 MHz to 10 mHz at 20° C. for (A) with an LMNO cathode prepared by the method from the prior art and (B) with cathode prepared by the method from this disclosure before and after cycling. The anodes are commercial.

FIG. 12: Graph showing charge/discharge profiles of two batteries (LMNO//Graphite) at C-rates of C/20 (0.05 C) and C/10 (0.1C) from 2.0 V to 5.0 V vs. Li⁺/Li at 20° C. One of the electrolyte-filled LMNO cathodes was prepared using the method from this disclosure, the second was prepared according to the prior art method.

FIG. 13: Graph showing charge/discharge profiles of a half battery (NMC811//LiM) at C-rates of C/20 (0.05 C) and C/10 (0.1 C) from 3.0 V to 4.2 V vs. Li⁺/Li at 20° C. The cathode was prepared by the method from the present disclosure.

FIG. 14: Graph showing the charge/discharge profiles of half-batteries (Graphite//LiM) cycled at C/20 (0.05 C) from 0.01 V to 1 V vs. Li⁺/Li, at 20° C. The electrolyte-filled 49.5 μm and 96.5 μm thickness anodes were prepared using the method from this disclosure.

FIG. 15: Graph showing the charge/discharge profiles of half-batteries (Silicon-Graphite//LiM) at a C rate of C/20 (0.05 C) from 0.01 V to 1 V with respect to Li⁺/Li. The electrolyte-filled 67.5 μm and 79.5 μm thickness anodes were prepared using the method from this disclosure.

FIG. 16: Graph comparing the coulombic efficiencies obtained for different electrode materials formulated according to the method according to the present disclosure and according to the method from the prior art.

### DETAILED DESCRIPTION

A first object of the present disclosure relates to a method for preparing an electrolyte-filled high charge per unit mass electrode for a high energy-density battery comprising two current collectors separated by an electrolyte composition, a separator and either:
(i) two electrodes (an anode, a cathode) in physical and electrical contact with the two current collectors, or
(ii) a cathode in contact only with one current collector, the second current collector in contact with the separator;
(iii) the method comprising the steps consisting of:
   a) preparing a mixture A comprising the electrolyte by mixing a metal salt with a solvent;
   b) mixing the mixture A with an active material to obtain a
   paste;
   a binder being added to one of steps a) or b); and
   c) forming the electrode with a predetermined thickness.

The battery has a high energy density, in particular due to the nature of the electrode, which is filled (or impregnated, which is equivalent in the meaning of the present disclosure) with electrolyte, as described above.

In a preferred embodiment, the metal salt comprises (i) a cation selected from lithium, sodium, potassium, calcium, magnesium and zinc, and (ii) an anion selected from hexafluorophosphate (PF6), tetrafluoroborate (BF4), bis(trifluoromethanesulfonyl)imide (TFSI), bis(fluorosulfonyl)imide (FSI), dicyanamide (DCA), 4,5-dicyano-2-(trifluoromethyl)imidazolide (TDI), fluorosulfonyl-(trifluoromethanesulfonyl)imide (FTFSI), (difluoroethanesulfonyl)imide (DFTFSI), bis(oxalato)borate (BOB), difluoro(oxalato)borate (DFOB).

Generally, Li-ion batteries according to the present disclosure can provide energy densities of 100 to 265 Wh/kg or 250 to 670 Wh/L. The sodium-ion battery according to the present disclosure can provide approximately 90 Wh/kg or approximately 270 Wh/L.

The method comprises a step a) of preparing an electrolyte by mixing a metal salt, such as a salt containing Li or Na, with a solvent and optionally a binder to obtain a mixture A.

As used herein, “electrolyte” or “electrolyte composition” means the mixture of the metal salt and the solvent.

In a preferred embodiment, the solvent is selected from an aprotic organic solvent, a protic organic solvent or a mixture thereof. The aprotic solvent may be selected from an ionic liquid, propylene carbonate, glyme, a salt concentrated in aqueous systems in solution.

In a preferred embodiment, the solvent is an ionic liquid.

As used herein, “ionic liquid” (IL) refers to a molten salt at a temperature below 100° C.

When the solvent is an ionic liquid, it comprises (i) a cation selected from alkylimidazolium, or based on alkylpyrrolidinium, morpholinium, pyridinium, piperidinium, phosphonium, ammonium and (ii) an anion selected from hexafluorophosphate (PF6), tetrafluoroborate (BF4), bis(trifluoromethanesulfonyl)imide (TFSI), bis(fluorosulfonyl)imide (FSI), dicyanamide (DCA), 4,5-dicyano-2-(trifluoromethyl)imidazolide (TDI), fluorosulfonyl-(trifluoromethanesulfonyl) imide (FTFSI), (difluoroethanesulfonyl) imide (DFTFSI), bis(oxalato)borate (BOB), difluoro(oxalato)borate (DFOB).

In a preferred embodiment, the chosen ionic liquids are of high quality [purity 99.9%; H₂O≤5 ppm; halides ≤1 ppm; lithium, sodium and potassium ≤10 ppm; nitrogen-containing organic compounds ≤10 ppm; Hazen color test 20-10].

The binder can be selected from the styrene butadiene latex copolymer (SBR), polyacrylonitrile (PAN), polyvinylidene fluoride (PVDF), polyvinylidene fluoride-co-hexafluoropropylene (PVdF-HFP), polyvinylidene fluoride-co-trichlorethylene, polymethyl methacrylate (PMMA), polyvinylpyrrolidone, polyvinyl acetate, polyethylene-co-vinyl acetate, polyethylene oxide, cellulose acetate, cellulose acetate butyrate, cellulose acetate priopionate, cyanoethyl pullulan, cyanoethyl polyvinyl alcohol, cyanoethyl cellulose, cyanoethyl saccharose, pullulan and carboxymethyl cellulose (CMC), polytetrafluoroethylene (PTFE) or a combination of at least two of them, as well as among polymers and their derivatives and/or composites such as polyaniline (PANI), poly(3,4-ethylenedioxythiophene) polystyrene sulfonate (PEDOT:PSS) composites, polyaniline-polyacrylic polymer composites (PANI:PAA) containing a conducting/carboxyl polymer, polypyrrole-carboxymethycellulose PPy/CMC, a hydrogel-based polymer such as (2-acrylamido-2-methyl-1-propanesufonic acid-co-acrylonitrile) (PMAPS), an ionic liquid polymer.

Examples of ionic liquid polymers that can be used as binders are compounds formed from poly(diallyldimethylammonium) with an anion selected from hexafluorophosphate (PF6), tetrafluoroborate (BF4), bis(trifluoromethanesulfonyl)imide (TFSI), bis(fluorosulfonyl)imide (FSI), dicyanamide (DCA), 4,5-dicyano-2-(trifluoromethyl)imidazolide (TDI), fluorosulfonyl-(trifluoromethanesulfonyl)imide (FTFSI) and (difluoroethanesulfonyl) (trifluoromethanesulfonyl)imide (DFTFSI), bis(oxalato)borate (BOB), difluoro(oxalato)borate (DFOB).

The method comprises a step b) consisting of mixing the mixture A obtained in step a) with an active material to obtain a paste, which is the material of the electrode, i.e. an electrolyte-filled electrode.

In addition, a binder is added in step a) or in step b), interchangeably.

In the battery according to the present disclosure, the electrolyte-filled electrode can be the cathode or the anode, or both. The electrolyte may be different or identical both in the cathode and in the anode that must be used in the same battery cell.

When the cathode is an electrode according to the present disclosure, the active material for the cathode is a material containing:
a. for a Li-ion battery: a lithium intercalating compound, selected from lithium iron phosphate, (LiFePO₄), lithium nickel-manganese-cobalt oxide, (LiNiₓMn_{y}Co_{z}O₂), the doped lithium nickel-manganese-cobalt oxide, (LiNiₓMn_{y}Co_{z}O₂), lithium cobalt oxide (LiCoO₂), doped lithium-cobalt oxide, lithium nickel oxide (LiNiO₂), doped lithium nickel oxide, lithium manganese oxide (LiMn₂O₄), doped lithium manganese oxide, lithium vanadium oxide, doped lithium vanadium oxide, lithium mixed metal oxides (LMNO), mixed transition metal oxides, mixed transition metals, doped lithium transition metal oxides, lithium vanadium phosphate, lithium manganese phosphate, lithium cobalt phosphate, mixed lithium and metal phosphates, metal sulfides, and combinations thereof.
b. for Na-ion and K-ion batteries:
   i a metal oxide such as VO₂, V₂O₅, H₂V₃O₈, b-MnO₂;
   ii the layered NaMOX such as Na0.71CoO₂, Na0.7MnO₂, b-NaMnO₂, Na1.1V3O7.9, Na₂RuO₃, Na₂/3[Ni1/3Mn₂/3]₂, Na0.67Co0.5Mn0.5O₂, Na0.66Li0.18Mn0.71Ni0.21Co0.008O²+x;
   iii 1D tunnel oxides such as Na0.44MnO₂, Na0.66[Mn0.66Ti0.34]O₂, Na0.61[Mn0.27Fe0.34Ti0.39]O₂;
   iv fluorides such as FeO0.7F1.3 and NaFeF₃;
   v sulfates such as Na₂Fe₂(SO₄)₃ and Eldfellite NaFe(SO₄)₂;
   vi phosphates NaFePO₄ and FePO₄; Na₃V₂(PO₄)₃, Na₃ V₂(PO₄)₃, Na₃ V₂(PO₄)₃@C@rGO, Na₃V₂(PO₄)₃/C, NaVOPO₄;
   vii pyrophosphates such as Na₂CoP₂O₇, Na₂FeP₂O₇ and Na3.12Fe2.44 (P₂O₇)₂;
   viii fluorophosphates such as NaVPO4F, Na₃ V₂(PO₄)₂F₃, Na3V2O2(PO4)2F@RuO2, Na₃(VO₁₋ₓPO₄)₂F1+2x, Na3.5V2(PO₄)₂F₃;
   ix mixed phosphates such as Na₇V₄(P₂O₇)₄(PO₄), Na₃MnPO₄CO₃;
   x hexacyanometates such as MnHCMn PBAs, Na1.32Mn [Fe(CN)₆]0.83.3.5H₂O, NaxCo[Fe(CN)₆]0.90·2.9H₂O;
   xi cathodes without critical metal such as Na₂C₆O₆, Na₆C₆O₆, SSDC, C₆Cl₄O₂/CMK, PTCDA-PI, poly(anthraquinonyl imide)s and functionalized graphite;
   xii Prussian white analogs
c. for Zn-ion and Mg-ion batteries:
   i transition metal oxides, MxV2O5 (M=Na, Ca, Zn, Mg, Ag, Li, etc.);
   ii a vanadate;
   iii layered and tunnel type vanadium-based compounds;
   iv polyanionic materials analogous to Prussian blue;
   v metal disulfides;
   vi NASICON-type compounds;
   vii AxMM0(XO4)3 (A: Li, Na, Mg, Zn, etc.; M: Mn, Ti, Fe, etc.; X:P, Si, S, etc.);
   viii organic materials such as quinones
d. for Mg-ion battery: layered sulfide/selenide
e. for Ca-ion battery:
   i 3D tunnel structures such as CaMn2O4 spinel
   ii chevrel phases such as CaMo6X8 (X═S, Se, Te)
   iii layered transition metal oxides
   iv Prussian blue analogs
   v Prussian white analogs

When the anode is an electrode according to the present disclosure, the active material for the anode is selected from:
a. for a Li-ion battery:
   i a lithium-containing titanium composite oxide (LTO);
   ii metals (Me) such as Si, Sn, Li, Zn, Mg, Cd, Ce, Ni and Fe;
   iii graphite, graphene, including particles of natural graphite, artificial graphite, meso-carbon microbeads (MCMB) and carbon (including soft carbon, hard carbon, carbon nanofibers and carbon nanotubes;
   iv silicon (Si), silicon/graphite composites, silicon combinations of germanium (Ge), tin (Sn), lead (Pb), antimony (Sb), bismuth (Bi), zinc (Zn), aluminum (Al), nickel (Ni), cobalt (Co), manganese (Mn), titanium (Ti), iron (Fe), and cadmium (Cd);
   v intermetallic alloys or compounds of Si, Ge, Sn, Pb, Sb, Bi, Zn, Al or Cd with other elements, the alloys or compounds being stoichiometric or non-stoichiometric;
   vi oxides, carbides, nitrides, sulfides, phosphides, selenides, and tellurides of Si, Ge, Sn, Pb, Sb, Bi, Zn, Al, Fe, Ni, Co, Ti, Mn or Cd, and mixtures or composites thereof;
   vii oxides (MeOx) of metals (Me);
   viii and composites of metals (Me) with carbon;
   ix MXene materials, [MXC where X=2, 3, 4).
b. for Na-ion and K-ion batteries:
   i oxide, sulfides, selenides, phosphides and MOF-based materials and carbon-based materials.
   ii the carbon-based materials comprise expanded graphite, N-doped expanded graphite, carbon black, amorphous carbon, carbon microspheres, hard carbon, meso-powerful soft carbon, carbon nanotubes, graphene nanosheets, nitrogen-doped CNTs, N-doped graphene foam, N-doped porous nanofibers, microporous carbon and cube-shaped porous carbon.
   iii the oxides comprise MnO2 nanoflowers, NiO nanosheets, porous SnO, porous SnO2 nanotubes, 3D porous Fe₃O4-C, porous CuO-RGO, MnO-CNT doped with ultrasmall nitrogen, CuS microflowers, SnS2-RGO, Co3S4-PANI, ZnS-RGO, NiS-RGO, Co3S4-PANI, MoS2-C, conducting WS2-carbon nanosheets doped with nitrogen, Sb3Se3-RGO nanorods, MoSe2-carbon fiber, Sn4P3 nanostructures with multishells, Sn4P3-C nanospheres, Se4P4, CoP nanoparticles, matrices of FeP nanorods on carbon cloth, MoP-C, CUP2-C, hollow NiO/Ni graphene, CoSe/C structured in shell-yellow doped with nitrogen.
   iv Na metal.
c. for Mg-ion and Zn-ion batteries: graphite, polynano crystalline graphite, expanded graphite, hard carbon/carbon black, hard-soft composite carbon, hard carbon microspheres, activated charcoal, a multi-layer F-doped graphene, nitrogen-doped carbon microsphere, hierarchically porous N-doped carbon, phosphorous and oxygen dual-doped graphene, nitrogen- and oxygen-doped carbon nanofiber, tire rubber derived hard carbon, porous carbon nanofiber paper, polycrystalline soft carbon, nitrogen-doped natural carbon nanofibers, nitrogen/oxygen double-doped hard carbon, K2Ti4O9 and K2Ti4O9.
d. for Zn-ion batteries:
   i zinc metal, zinc alloys
   ii graphite and carbonaceous materials
e. for Ca-ion battery:
   i calcium-metal alloys
   ii tin metal
   iii graphite and carbonaceous materials

In a particular embodiment of the present disclosure, a conducting material is mixed with the mixture A and the active material in step b) of the method.

In an advantageous embodiment of the present disclosure, the electrolyte comprises an additive, for example LiTDI. This additive improves the capacity of the battery.

The conducting material may be selected from carbon black consisting of acetylene black, carbon black, ketjen black, black to tunnel, furnace black, lamp black or thermal black; graphite, such as natural graphite or artificial graphite and a mixture thereof, or a combination of at least two of them; a conducting material comprising conducting fibers, such as carbon fibers or metal fibers; a metal powder, such as a fluorocarbon, aluminum or nickel powder; conducting metal monocrystalline filaments, such as zinc oxide, or potassium titanate; titanium dioxide; a polyphenylene derivative.

The paste obtained in step b) is then mechanically treated to form the electrode.

The method for forming the electrode in step c) can be selected from all the techniques known to a person skilled in the art. Preferably, it is selected from the paste rolling technique, the 3D printing technique for paste, an extrusion technique and a jet milling technique. The formation of the electrode may also comprise a step of drying the paste. This can be carried out either by direct drying (in an oven or vacuum oven at 80° C.) or by producing the electrode in a dry part with a relative humidity of less than 0.5%; such a condition may be obtained for example in an anhydrous part or in an argon atmosphere. In an argon atmosphere, the water content is generally less than 5 ppm and the oxygen content is generally less than 1 ppm.

In a preferred embodiment, the percentage by mass of electrolyte:dry electrode material is within a ratio [15:85] and preferably in a ratio [30:75], or even more preferably in a ratio [40:60]. The optimization of this ratio makes it possible to optimize the capacity of the battery and to obtain a mechanically stable paste. As an example, for 100 g of electrolyte-filled electrode, the electrode comprises 15 g of electrolyte and 85 g of dry electrode material (LFP+C65+PTFE). The optimization of this ratio may be based on the absorption of electrolyte in the electrode material during the method to obtain a mechanically stable electrolyte-filled electrode without excess electrolyte. Another optimization method comprises measuring the series resistance and the electrochemical performance.

The preparation of the electrodes according to the present disclosure makes it possible to improve the surface charge of the electrodes, the energy densities and the safety of the batteries, for example for automotive, aeronautics, space, portable tools, robots. The battery comprising the electrodes prepared by the method from the present disclosure can also be applied for the ion gel-based sensory sensors (pressure/deformation sensors, double-layer electric transistors, etc.), flexible screens and flexible actuators, portable devices, depending on the choice of the nature of the solvent and the active material.

A second object of the present disclosure relates to an apparatus for implementing the method as defined above.

The apparatus intended to manufacture an electrode according to the present disclosure comprises:
means for manufacturing a paste resulting from mixing a metal salt, a solvent, a binder and an active material at room temperature,
means for forming the electrode from the mechanical treatment of the paste, and it is characterized in that the metal parts capable of being in contact with the electrolyte are protected by an anti-corrosion coating.

Indeed, it should be noted that the electrolyte may be corrosive and that it is then necessary to apply a protective layer to avoid damaging the apparatus. This surface treatment may consist of a metal coating using metals having corrosion resistance properties (for example tantalum, aluminum or copper) or by applying a polymer type coating.

A third object of the present disclosure relates to an electrolyte-filled high charge per unit mass electrode for a high energy-density battery obtained by the method defined above.

A fourth object of the present disclosure relates to a high energy-density battery comprising at least one electrolyte-filled electrode prepared in accordance with the method described above, a separator and two current collectors, wherein:
(i) when the battery comprises two electrodes, the current collectors are respectively connected to the electrodes (i.e. cathode, anode), and the electrodes consist of:
   a. an anode electrode prepared in accordance with the method as defined above, and a cathode electrode; or
   b. a cathode electrode prepared in accordance with the method as defined above, and an anode electrode; or
   c. a cathode electrode and an anode electrode both prepared in accordance with the method as defined above; or
      (ii) when the battery comprises a cathode electrode only, the current collectors are respectively connected to the cathode and to the separator, and the cathode electrode is prepared in accordance with the method as defined above.

Such a battery can thus comprise both an electrolyte-filled cathode and an electrolyte-filled anode prepared in accordance with the method according to the present disclosure, or an electrolyte-filled cathode prepared in accordance with the method according to the present disclosure and an anode, or an electrolyte-filled anode prepared in accordance with the method according to the present disclosure and a cathode, or only an electrolyte-filled cathode prepared in accordance with the method according to the present disclosure (anode-free battery). The electrode that is not prepared in accordance with the method according to the present disclosure may or may not be of commercial type.

The separators may be constituted by:
a microporous polymer membrane that is a semi-crystalline polyolefin such as polyethylene (PE), polypropylene (PP), high-density polyethylene (HDPE), PE-PP, PS-PP, polyethylene terephthalate-polypropylene (PET-PP) mixtures, poly(vinylidene fluoride (PVDF), polyacrylonitrile (PAN); polyoxymethylene, poly(4-methyl-1-pentene); non-woven fabric mat such as cellulose, polyolefin, polyamide, polytetrafluoroethylene (PTFE), poly(vinylidene fluoride-co-hexafluoropropylene (PVDF-HFP), polyvinyl chloride (PVC), polyester. Other types of polymers are polyolefin-based materials as such, and mixtures thereof, such as polyethylene-polypropylene. Grafted polymers such as separators of polyethylene grafted to siloxane, microporous grafted to poly(methylmethacrylate); polyvinylidene fluoride (PVDF) nanofiber mesh, polytriphenylamine-modified separator (PTPAn). Polymer electrolytes such as ionic liquid polymer electrolytes.

Examples of such ionic liquid polymers are compounds formed from poly(diallyldimethylammonium) with an anion selected from hexafluorophosphate (PF6), tetrafluoroborate (BF4), bis(trifluoromethanesulfonyl)imide (TFSI), bis(fluorosulfonyl)imide (FSI), dicyanamide (DCA), 4,5-dicyano-2-(trifluoromethyl)imidazolide (TDI), fluorosulfonyl-(trifluoromethanesulfonyl)imide (FTFSI) and (difluoroethanesulfonyl) (trifluoromethanesulfonyl)imide (DFTFSI), bis(oxalato)borate (BOB), difluoro(oxalato)borate (DFOB).
Ionic liquid polymers also with ionic liquids (or without), polymer/copolymer electrolytes mixed with polyethylene oxide (PEO), any other combination of polymer and ionic liquids electrolytes or a combination of ionic liquids and ionic liquid polymer.
Polymerizable ionic liquid;
An inorganic composite separator such as metal oxide powders (TiO₂, ZrO₂, LiAlO₂, Al₂O₃, MgO, CaCO₃) in a polymer matrix (PVDF-HFP, PTFE), AIO (OH)/polyvinyl alcohol (PVA) on PET, ceramic separators such as alumina or ceramic particles mixed with polymers or a combination of polymers and/or ionic liquids, surface-coated polymer such as a gel-like polymer film (PEO, PVDF-HFP) on microporous membranes; impregnating a gel polymer electrolyte such as an ionic liquid-based electrolyte in microporous membranes; glass fibers; conducting glass separators. The separators may also comprise solid-state electrolytes such as solid ceramic electrolytes and solid polymer electrolytes.

The current collector operates as an electrical conductor between the electrode and the external circuits as well as a support for the coating of the electrode materials. In this case, the electrolyte-filled electrode is mechanically stable even without the current collector. The current collectors may have different textures such as mesh, foam, film, micro-grid, may be porous, have varied shapes, be two-dimensional, three-dimensional. The electrically conducting porous layers may be selected from metal foam, metal mesh or screen, perforated sheet-based structure, metal fiber mat, metal nanowire mat, conducting polymer nanofiber mat, conducting polymer foam, polymer-coated conducting fiber foam, carbon foam, graphite foam, carbon aerogel, carbon xerox gel, graphene foam, graphene oxide foam, reduced graphene oxide foam, carbon fiber foam, graphite fiber foam, exfoliated graphite foam, or a combination thereof; the current collector may also comprise any one element among stainless steel, aluminum; nickel, titanium, platinum, copper; a stainless steel surface treated with carbon, nickel, titanium or silver; and an aluminum-cadmium alloy, or a combination of at least two of them.

### EXAMPLES

### Example 1: Preparation of an Electrolyte-Filled Electrode

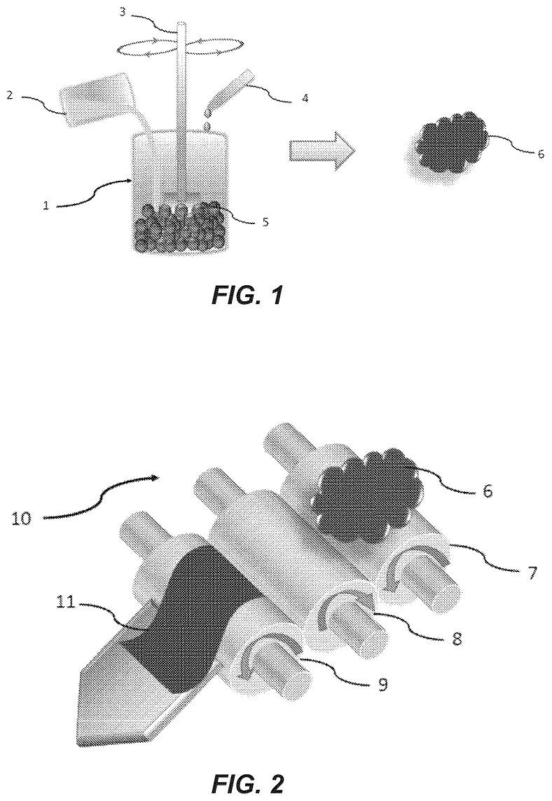

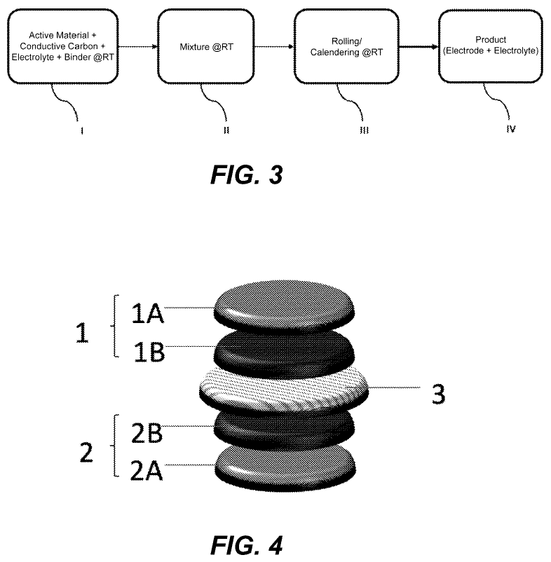

Referring to FIGS. 1 and 3, a first step I consists in pouring an electrolyte at ambient temperature with a liquid/gel formulation (2), a binder (4), an active electrode material and a conducting material (5) in a container (1) equipped with a mechanical kneading blade (3). This blade (3) ensures (step II) the mixing and kneading of the components poured into the container (1), without solvent with a Volatile Organic Component (VOC). The product obtained at the end of this step II implemented at room temperature is a carbon paste (6).

With reference to FIGS. 2 and 3, the carbon paste (6) is treated (step III) at room temperature in a calendering machine (10) comprising three rollers (7), (8), (9), so as to produce a paste tape (11) constituting (step IV) a combination of an electrode and an electrolyte. A practical electrode processing method that takes into account the optimization of the electrolyte/electrode ratio to ensure that the device is filled with materials fully exploited in terms of active material capacity, to effectively increase the energy density of the device at different thicknesses, without additional excess of materials or electrolyte that do not contribute to charge storage.

The optimization process begins by determining the electrolyte mass required for a known electrode mass. It consists in determining a minimum quantity of electrolyte to obtain a mechanically stable paste followed by additional optimization based on the physical and electrochemical performance.

The steps for preparing the electrodes comprise:
introducing a defined amount of binder dispersed in the electrolyte;
introducing an optimized percentage by mass of electrolyte relative to the active material and the conducting material;
folding and/or kneading the electrode material with an electrolyte (e.g. a mixer);
working the paste into a paste ready to be used as electrode material containing the electrolyte,
drying the electrolyte impregnated electrode material at elevated temperature (60-100° C.) under vacuum. Temperature will strictly depend on the type of electrolyte, its components in terms of thermal stability. Drying will not be necessary if this method is carried out in a dry room with a relative humidity of less than 0.5%.

The electrodes are cut into discs (1B and 2B) and are placed on the current collectors (1A and 2A), assembled in a button battery (FIG. 4) with a separator (3) between the cathode (1B) and the anode (2B).

The electrode is then ready to be used in a battery. Production conditions require a dry room and a use for application, or an argon environment with a water content of less than 5 ppm and an oxygen content of less than 1 ppm, or must comprise a drying step.

NB: The data relating to the electrodes are then measured without taking into account the thickness of the current collector.

### Example 2: Preparation of the Button Battery

The lithium-based button half-batteries and button batteries (CR2032) are assembled in a glove box under an argon atmosphere of less than 1 ppm of O₂ and H₂O. The electrodes were manufactured by mixing and kneading active powder materials, ionic liquids or ionic liquid-based formulations containing lithium salt or sodium salt as electrolyte (less than 5 ppm water from SOLVIONIC SA) and polytetrafluoroethylene (Fuel Cell Earth, Massachusetts) as binder at room temperature. The electrodes filled with ionic liquid (cathodes and anodes) are cut into 13 mm diameter discs, with an optimized thickness of between 10 and 1000 μm, preferably between 30 μm and 1000 μm, preferably between 100 and 1000 μm, preferably between 200 and 700 μm, even more preferably between 100 and 500 μm or between 30 and 700 μm, and quite preferably between 10 and 500 μm, and laminated or calendered on current collectors (aluminum and copper).

The electrodes were separated by a 25 to 180 μm separator, which can be made of different materials. The button batteries were then sealed by a button battery crimping instrument before the electrochemical characterizations.

An electrochemical impedance spectroscopy (EIS) and galvanostatic cycling measurements were performed using a VMP3 (BioLogic) potentiostat and a computerized multi-channel battery cycler (Arbin Inc). The EIS was done on two-electrode cells at a DC bias of 0 V by applying an RMS sine wave of about 5 mV at frequencies from about 80 kHz to about 10 mHz. The galvanostatic cycling is obtained by charging and discharging the cells at different constant currents at the maximum and minimum cutoff voltages specific to the different active materials.

### Example 3: Preparation of an Electrolyte-Filled Cathode

47.02% by weight of LifePO₄+C65+PTFE (polytetrafluoroethylene) respectively as active material, conducting material and binder, and 52.98% wt of LiTFSI: PYR14FSI (ratio 1:9 mol) as electrolyte
Aluminum current collector=25 μm

0.1 g of PTFE is first added to 1.127 g of electrolyte [LiTFSI: PYR14FSI (1:9 mol)], the mixture is then added to the pulverulent mixture of 0.80 g of LifePO₄ and 0.1 g of C65. The resulting mixture is then kneaded and a mechanically stable electrolyte-filled electrode is formed.

The electrolyte-filled cathode material is calendered using a calendering machine at different successive controlled thicknesses (e.g. 400 μm-300 μm-250 μm-200 μm, etc.) between two 30 μm aluminum sheets each to obtain the desired surface density. For each thickness, 13 mm electrode discs are cut and then placed on the current collector. A cathode is formed.

This cathode weighs 40.75 mg with a LiFePO₄ load of 15.33 mg. The percentage by weight of electrolyte relative to the cathode material is 52.98%.

### Example 4: Comparison of the Capacities of Two Batteries Comprising Electrodes of Different Thickness

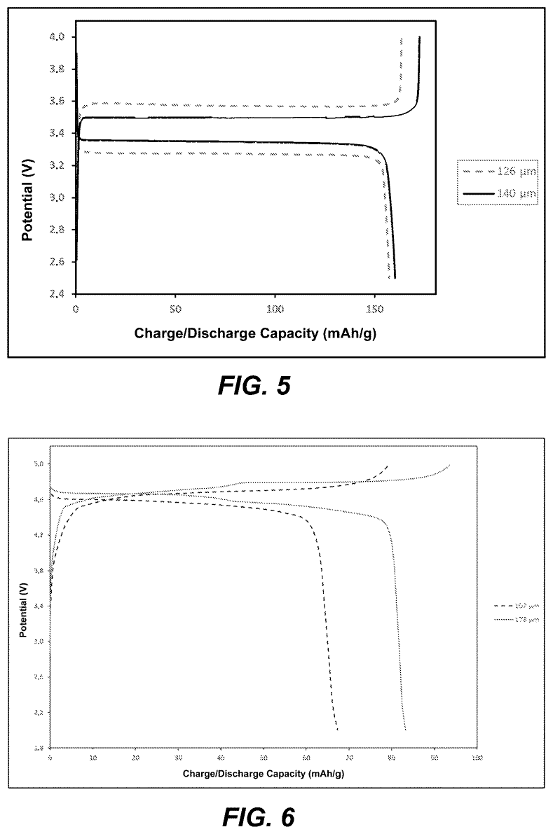

Table 1 and FIG. 5 illustrate the characteristics of two batteries containing electrodes prepared according to the method according to the present disclosure. This example shows that the surface capacity of the battery improves as the electrode thickness increases. The batteries were prepared according to Example 3.

TABLE 1
Characteristics of the half-batteries
with an electrolyte-filled electrode.

| | | Discharge | Surface | Coulombic |
|---|---|---|---|---|
| Electrode | Mass of active | capacity | capacity | efficiency |
| thickness (μm) | material (mg) | (mAh/g) | (mAh/cm²) | (%) |
| 126 | 13.83 | 156.84 | 1.63 | 96.22 |
| 140 | 15.33 | 159.91 | 1.85 | 97.00 |

FIG. 5 shows an increase in the discharge capacity from 156.84 mAh/g to 159.91 mAh/g when the thickness of the electrode increases from 126 μm to 140 μm. The ratio of this increase can be improved by optimizing the composition of the electrolyte as well as the test conditions such as pressure, temperature. In this example, the hysteresis of the cell containing a thicker electrode (140 μm) is less than the cell containing a thinner electrode (126 μm). The hysteresis is important; it makes it possible to measure the efficiency of the cell. This example shows a reduction and therefore an improvement in the hysteresis by increasing the thickness. The reduction in hysteresis is well observed in coulombic efficiency measurements; it goes from 96.22 to 97%.

### Example 5: Electrolyte-Filled Electrode Containing an Ionic Liquid in Phosphonium in a Lithium Nickel Manganese Oxide (LMNO) Cathode

61.92% wt of LMNO+C65+PTFE (polytetrafluoroethylene) respectively as active material, conducting material and binder, 38.08% wt of 1 mol/L LiFSI in P1113FSI as electrolyte.
Aluminum current collector=19 μm

0.079 g of PTFE is first added to 0.616 g of electrolyte [1 mol/L LiFSI in P1113FSI], the mixture is then added to the pulverulent mixture of 0.842 g of LMNO and 0.081 g of C65. The resulting mixture is then kneaded, the electrolyte is added to wet all of the particles (+0.230 g) and a mechanically stable electrolyte-filled electrode is formed.

The electrolyte-filled cathode material is calendered using a calendering machine at different successive controlled thicknesses (e.g. 400 μm-300 μm-250 μm-200 μm, etc.) between two 30 μm aluminum sheets each to obtain the desired surface density. For each thickness, 13 mm electrode discs are cut and then deposited on the current collector. A cathode is formed.

TABLE 2
Characteristics of electrolyte-filled electrodes.

| Calendering machine | Electrode | Electrode mass | Mass of active |
|---|---|---|---|
| adjustment (μm) | thickness (μm) | (mg) | material (mg) |
| 400 | 239 | 70.1 | 36.47 |
| 300 | 173 | 52.2 | 27.18 |
| 250 | 150 | 44.4 | 23.10 |
| 200 | 107 | 29.2 | 15.19 |

One of the cathodes of Table 2 weighs 52.2 mg with an LMNO load of 27.18 mg and has a 173 μm thickness. The percentage by weight of electrolyte relative to the cathode material is 38.08%.

Table 3 groups together the characteristics obtained at 20° C. for Li-ion batteries based on LMNO and comprising the following electrolyte: 1 mol/L LiFSI in P1113FSI.

TABLE 3
Characteristics of the batteries with an electrolyte-filled
LMNO electrode and a commercial graphite electrode at 0.05 C.

| Electrode | Mass of active | Surface capacity | Discharge capacity |
|---|---|---|---|
| thickness (μm) | material (mg) | (mAh/cm²) | (mAh/g) |
| 107 | 15.19 | 0.77 | 67.45 |
| 173 | 27.18 | 1.71 | 83.32 |

FIG. 6 shows an increase in discharge capacity from 67.45 mAh/g to 83.32 mAh/g with an increase in the electrode thickness from 107 μm to 173 μm with a C to C/20 level.

### Example 6: Electrolyte-Filled Lithium Nickel-Manganese Oxide (LMNO) Electrode Containing an Ionic Liquid and Commercial Graphite (Anode)

61.48% by weight of LMNO+C65+PTFE (polytetrafluoroethylene) respectively as active material, conducting material and binder, 38.52% by weight of 1 mol/L LiFSI in PYR13FSI+0.05 mol/L LiTDI as electrolyte.
Aluminum current collector=19 μm

0.080 g of PTFE is first added to 0.627 g of electrolyte [1 mol/L LiFSI in PYR13FSI+0.05 mol/L LiTDI]; the mixture is then added to the pulverulent mixture of 0.84 g of LMNO and 0.081 g of C65. The resulting mixture is then kneaded and a mechanically stable electrolyte-filled electrode is formed.

The electrolyte-filled cathode material is calendered using a calendering machine at different successive controlled thicknesses (e.g. 350 μm-300 μm-200 μm, etc.) between two 30 μm aluminum sheets each to obtain the desired surface density. For each thickness, 13 mm electrode discs are cut and then deposited on the current collector. A cathode is formed.

TABLE 4
Characteristics of electrolyte-filled electrodes.

| Calendering machine | Electrode | Electrode mass | Mass of active |
|---|---|---|---|
| adjustment (μm) | thickness (μm) | (mg) | material (mg) |
| 350 | 196 | 58.8 | 30.37 |
| 300 | 179 | 52.2 | 26.96 |
| 200 | 132 | 41.1 | 21.23 |

One of the cathodes of Table 4 weighs 52.2 mg with an LMNO load of 26.96 mg and a 179 μm thickness. The percentage by weight of electrolyte relative to the cathode material is 38.52%.

Table 5 groups together the characteristics obtained at 20° C. for Li-ion batteries based on LMNO and comprising the following electrolyte: 1 mol/L LiFSI in PYR13FSI+0.05 mol/L LiTDI.

TABLE 5
Characteristics of batteries with an electrolyte-filled LMNO electrode
(method from this disclosure) and a commercial graphite electrode
(method from the prior art) at 0.05 C and 0.1 C.

| | Mass of | | | | | | |
|---|---|---|---|---|---|---|---|
| Electrode | active | | | Charge | Discharge | | Surface |
| thickness | material | | | capacity | Capacity | Efficiency | capacity |
| (μm) | (mg) | C-rate | | (mAh/g) | (mAh/g) | (%) | (mAh/cm²) |
| 132 | 21.23 | 0.05 | C | 143.2 | 134.6 | 93.98 | 2.15 |
| | | 0.1 | C | 135.1 | 125.0 | 92.49 | 2.00 |
| 179 | 26.96 | 0.05 | C | 134.1 | 128.4 | 95.75 | 2.60 |
| | | 0.1 | C | 134.0 | 123.5 | 92.15 | 2.51 |

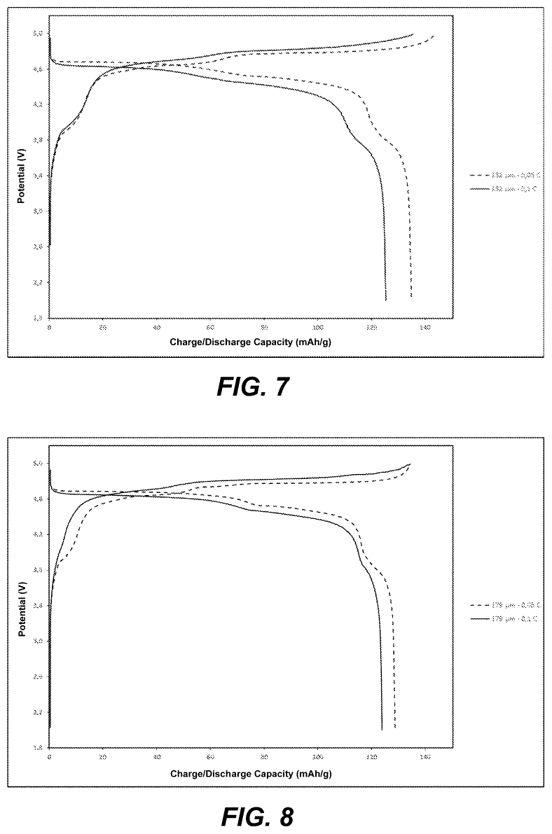

FIGS. 7 and 8 show that electrodes with a high surface density of LMNO can be prepared without cracking/splitting the electrode. Since the cracking problem was a major difficulty encountered with the methods from the prior art, this result is a major advantage of the present disclosure.

In this example at C/20, the hysteresis of the cell prepared with a thicker electrode (179 μm) (FIG. 8) is less significant than that of the cell with a thinner thickness (132 μm) (FIG. 7). The hysteresis is important in measuring the efficiency of the cell. This example shows an improvement (a reduction) of the hysteresis by increasing the thickness. This improvement is reinforced by the efficiencies cited in Table 6, where the 179 μm electrode has an efficiency of 95.75% compared with an efficiency of 93.98% for the 132 μm electrode. These results show an improvement in the energy density with the electrode of 179 μm at 0.05 C (surface capacity of 2.60 mAh/cm²).

In FIG. 8, the increase in charge rate from C/20 to C/10 (charge and discharge from 20 hours to 10 hours), a loss of capacity was observed, it changed from 128.4 to 123.5 mAh/g. This loss of capacity is smaller with a thickness of 179 μm compared with a thickness of 132 μm (FIG. 7). An increase in electrode thicknesses with the method from the present disclosure can improve the hysteresis of the cell and thus the coulombic efficiency of the cycling.

Comparison between FIG. 7 and FIG. 8: the difference in capacity between C/20 and C/10 is less significant with the largest thickness, there is less capacity when the charging and discharging speed is increased with a greater thickness.

### Example 7: Electrolyte-Filled LMNO Electrode Containing Ionic Liquid without LiTDI (Comparative Example)

60.63% wt of LMNO+C65+PTFE (polytetrafluoroethylene) respectively as active material, conducting material and binder, 39.37% wt of 1 mol/L LiFSI in PYR13FSI as electrolyte.
Aluminum current collector=19 μm

0.081 g of PTFE is first added to 0.65 g of electrolyte [1 mol/L LiFSI in PYR13FSI]; the mixture is then added to the pulverulent mixture of 0.84 g of LMNO and 0.08 g of C65. The resulting mixture is then kneaded and a mechanically stable electrolyte-filled electrode is formed.

The electrolyte-filled cathode material is calendered using a calendering machine at different successive controlled thicknesses (e.g. 350 μm-300 μm-200 μm, etc.) between two 30 μm aluminum sheets each to obtain the desired surface density. For each thickness, 13 mm electrode discs are cut and then placed on the current collector. A cathode is formed.

One of the cathodes weighs 34.1 mg with an LMNO load of 17.35 mg and a 113 μm thickness. The percentage by weight of electrolyte relative to the cathode material is 38.52%. Table 6 groups together the characteristics obtained at 20° C. for Li-ion batteries based on LMNO and comprising the following electrolyte: 1 mol/L LiFSI in PYR13FSI.

TABLE 6
Characteristics of batteries with an electrolyte-filled LMNO
electrode and a commercial graphite electrode at 0.05 C.

| | Mass of | | | | | |
|---|---|---|---|---|---|---|
| Electrode | active | | Charge | Discharge | | Surface |
| thickness | material | | capacity | capacity | Efficiency | capacity |
| (μm) | (mg) | C-rate | (mAh/g) | (mAh/g) | (%) | (mAh/cm²) |
| 113 | 17.35 | 0.05 C | 116.6 | 107.5 | 92.14 | 1.4 |

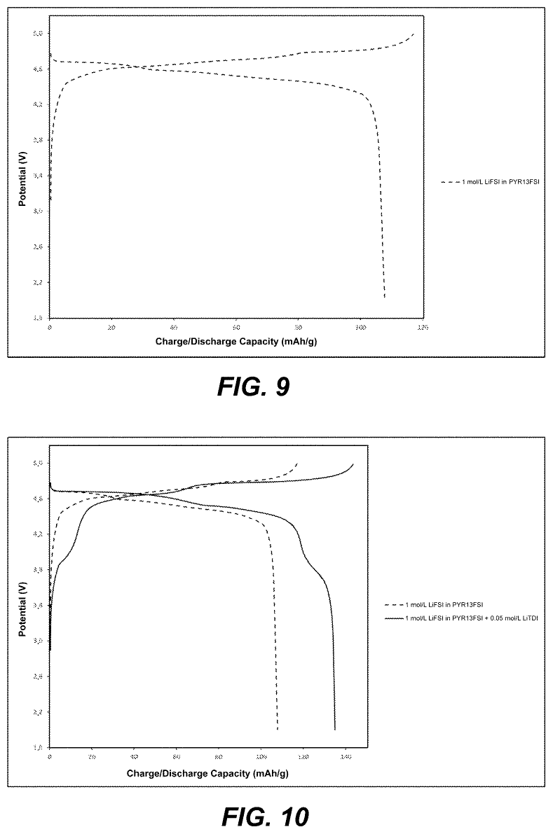

The charge/discharge characteristics are shown in FIG. 9.

This example shows that the cell can be cycled. A capacity of 107.5 mAh/g was obtained in C/20 with coulombic efficiencies of 92.14%. The coulombic efficiency of the cells and their discharge capacities of the preceding examples are more advantageous compared to this example where the electrolyte does not contain an additive.

Comparison with and without Additive (LiTDI)

TABLE 7
Characteristics of batteries with an electrolyte-filled LMNO electrode
(method from this disclosure) and a commercial graphite electrode
(prior art method) at 0.05 C with and without additive.

| | | Mass of | | | | | |
|---|---|---|---|---|---|---|---|
| | Electrode | active | | Charge | Discharge | | Surface |
| Presence | thickness | material | | capacity | capacity | Efficiency | capacity |
| of LiTDI | (μm) | (mg) | C-rate | (mAh/g) | (mAh/g) | (%) | (mAh/cm²) |
| None | 113 | 17.35 | 0.05 C | 116.6 | 107.5 | 92.14 | 1.40 |
| Where | 132 | 21.23 | 0.05 C | 143.18 | 134.56 | 93.98 | 2.15 |

The charge/discharge characteristics of the two pills at 0.05C are shown in FIG. 10.

In comparison between the electrodes prepared with and without LiTDI, the surface capacity of the cell with the electrode containing LiTDI was improved by more than 50% for an increase of 20% of active material mass relative to the cell without LiTDI.

### Example 8: Comparison of a Commercial Electrode and an Electrode Prepared According to the Method from the Present Disclosure

61.36% by weight of LMNO+C65+PTFE (polytetrafluoroethylene) respectively as active material, conducting material and binder, 38.64% by weight of 1 mol/L LiFSI in PYR13FSI+0.05 mol/L LiTDI as electrolyte.
Aluminum current collector=19 μm

0.080 g PTFE is first added to 0.632 g of electrolyte [1 mol/L LiFSI in PYR13FSI+0.05 mol/L LiTDI]; the mixture is then added to the pulverulent mixture of 0.844 g of LMNO and 0.08 g of C65. The resulting mixture is then kneaded and a mechanically stable electrolyte-filled electrode is formed.

The electrolyte-filled cathode material is calendered using a calendering machine at different successive controlled thicknesses (e.g. 200 μm-150 μm, etc.) between two 30 μm aluminum sheets each to obtain the desired surface density. For each thickness, 13 mm electrode discs are cut and then placed on the current collector. A cathode is formed.

One of the cathodes weighs 18.4 mg with an LMNO load of 9.49 mg and a 56 μm thickness. The percentage by weight of electrolyte relative to the cathode material is 38.64%.

Table 8 groups together the characteristics obtained at 20° C. for Li-ion batteries based on LMNO and comprising the following electrolyte: 1 mol/L LiFSI in PYR13FSI+0.05 mol/L LiTDI. A comparison is made between a commercial cathode and a cathode produced according to the method from the present disclosure.

TABLE 8
Characteristics of the batteries with an LMNO electrode and
a commercial graphite electrode at 0.05 C and 0.1 C at 20° C.

| | | Mass of | Expected | | | | | | | |
|---|---|---|---|---|---|---|---|---|---|---|
| | Electrode | active | surface | | | | Charge | Discharge | | Surface |
| | thickness | material | capacity | ESR | | | capacity | capacity | Efficiency | capacity |
| Electrodes | (μm) | (mg) | (mAh/cm²) | (Ohm · cm²) | C-rate | | (mAh/g) | (mAh/g) | (%) | (mAh/cm²) |
| Commercial | 42.5 | 9.03 | 1 | 5.50 | 0.05 | C | 126.50 | 109.27 | 86.38 | 0.74 |
| | | | | | 0.1 | C | 117.94 | 112.18 | 95.12 | 0.76 |
| Method | 56 | 9.49 | 1.05 | 5.68 | 0.05 | C | 136.69 | 120.21 | 87.94 | 0.859 |
| from the | | | | | 0.1 | C | 127.09 | 121.39 | 95.51 | 0.868 |
| present | | | | | | | | | | |
| disclosure | | | | | | | | | | |

An electrode (cathode) prepared with the method from this disclosure was compared with a commercial electrode (prepared with a method from the prior art).

The anodes of these examples are graphite electrodes, prepared in whole cell configuration with a method known from the prior art.

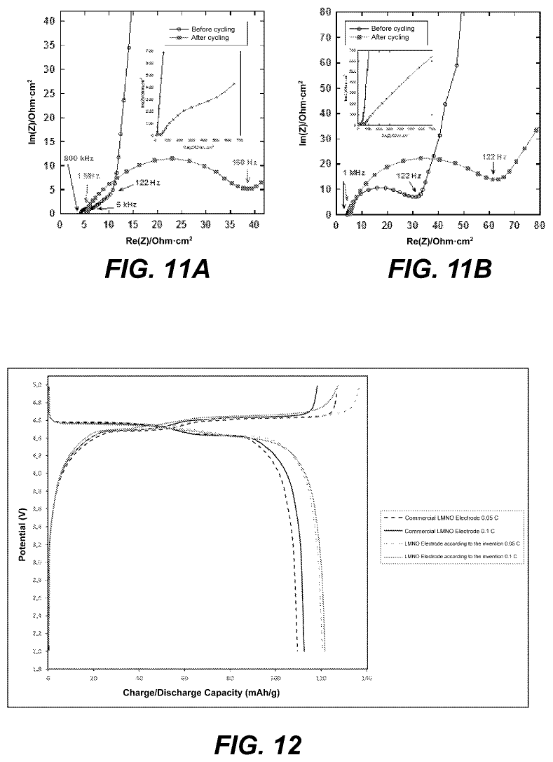

FIG. 11 shows that the resistances measured by impedance spectroscopy of the cells prepared with the cathodes from the prior art method and those prepared by the method from this disclosure are at 4.13 Ω·cm² and 4.30 Ω·cm² before cycling respectively. Although the resistances before cycling are of the same order of magnitude, the profiles are different. In FIG. 11A (before cycling), from 6 kHz to 122 Hz, the profile follows a 45° angle that corresponds to a diffusion phenomenon, in particular the diffusion (Warburg) of electrolyte in the dry electrode thickness. In contrast, this phenomenon was not observed in FIG. 11B (before cycling); this shows that with the method from this disclosure there is good wettability of the electrodes by the electrolyte. The profiles of these two figures (FIGS. 11A and 11B) after cycling follow the same trend.

FIG. 12 shows the comparison of charge/discharge cycles between a cell composed of an LMNO cathode prepared with the method from this disclosure, and a cell composed of an LMNO cathode prepared with the prior art method. Graphite anodes are prepared with the prior art. The cells are cycled at C/20 (0.05 C) and C/10 (0.01 C) at 20° C.

The electrolyte is 1 mol/L LiFSI in PYR13FSI+0.05 mol/L LITDI.

An increase in the masses of active material of 5% is observed between the two electrodes (from 9.03 mg to 9.49 mg). The method from this disclosure allows an increase of 16% (0.74 mAh/cm² to 0.86 mAh/cm²) in surface capacity with only 5% difference in the mass of active material. These 16% increases have a repercussion on the discharge capacity, which increases 10% at C/20. Indeed, for the discharge capacity values corresponding to these electrodes, an increase of 10% is observed (from 109.27 mAh/g to 120.21 mAh/g), the electrode prepared by the present disclosure having the highest discharge capacity when the cell is discharged from 5 V to 2 V compared to Li⁺/Li. This observation shows an improvement in capacity in charge and in discharge with the method from this disclosure, which makes it possible to store more charge.

### Example 9: Electrolyte-Filled NMC811 Electrode

56.48% by weight of NMC811+C45+PTFE (polytetrafluoroethylene) respectively as active material, conducting material and binder, 43.52% by weight of 1 mol/L LiFSI in PYR13FSI+5% wt FEC as electrolyte
Aluminum current collector=16 μm

0.0997 g of PTFE is first added to 0.773 g of electrolyte [1 mol/L LiFSI in PYR13FSI+5% wt FEC]; the mixture is then added to the pulverulent mixture of 0.802 g of NMC811 and 0.102 g of C45. The resulting mixture is then kneaded and a mechanically stable electrolyte-filled electrode is formed.

The electrolyte-filled cathode material is calendered using a calendering machine at different successive controlled thicknesses (e.g. 300 μm-200 μm, etc.) between two 30 μm aluminum sheets each to obtain the desired surface density. For each thickness, 13 mm electrode discs are cut and then placed on the current collector. A cathode is formed.

One of the cathodes weighs 47.2 mg with an NMC811 load of 21.40 mg and a 288 μm thickness. The percentage by weight of electrolyte relative to the cathode material is 43.34%.

Table 9 groups the characteristics obtained for Li-ion batteries at 20° C. based on NMC811 and comprising the following electrolyte: 1 mol/L LiFSI in PYR13FSI+5% wt FEC.

TABLE 9
Characteristics of a half-battery with an electrolyte-
filled NMC811 electrode at different C-rate.

| | Mass of | | | | | | |
|---|---|---|---|---|---|---|---|
| Electrode | active | | | Charge | Discharge | | Surface |
| thickness | material | | | capacity | capacity | Efficiency | capacity |
| (μm) | (mg) | C-rate | | (mAh/g) | (mAh/g) | (%) | (mAh/cm²) |
| 288 | 21.40 | 0.05 | C | 172.93 | 172.99 | 100 | 2.79 |
| | | 0.1 | C | 159.3 | 159.2 | 99.9 | 2.57 |

This example shows that the NMC 811 electrode was prepared with a high surface basis weight of 2.79 mAh/cm² in C/20 without cracking of the electrode (thickness to 288 μm). A commercial 2 mAh/cm² electrode of has a thickness of 51 μm (without current collector). Despite the significant thickness, the coulombic efficiency is high, at 100% when the cell cycled at C/20, and 99.9% at a more rapid C-rate, C/10.

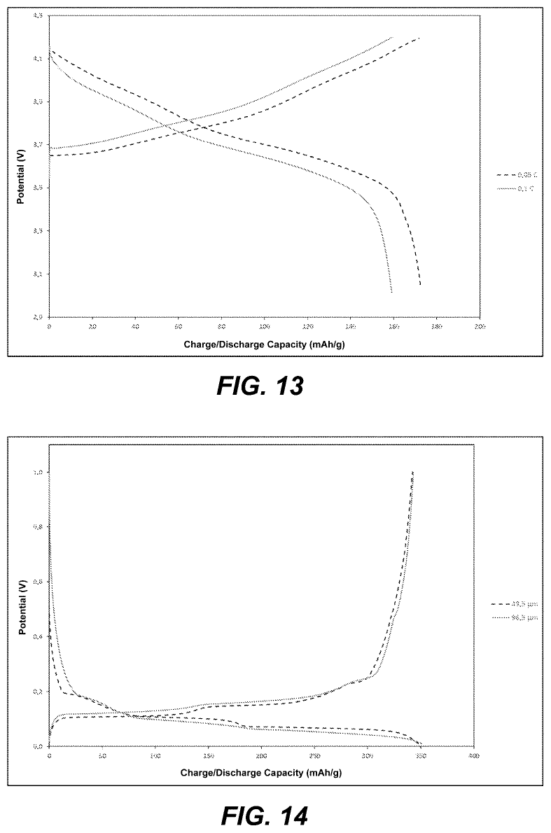

FIG. 13 shows a charge/discharge cycle of a cell comprising an electrolyte-filled NMC811 cathode (1 mol/L LiFSI in PYR13FSI+5% wt FEC) prepared using the method from this disclosure, and an anode of lithium metal, at C/20 (0.05 C) and C/10 (0.01 C) at 20° C. The specific capacities of 172.93 mAh/g and 172.99 mAh/g were obtained for charging and discharging, with a coulombic efficiency of 100% when this cell was cycled at C/20; 159.3 mAh/g and 159.2 mAh/g, with a coulombic efficiency of 99.9% when the cell cycled at C/10.

The efficiency on the C-rates of 0.05 C and 0.1 C is greater for the electrodes produced according to the method from the present disclosure.

### Example 10: Electrolyte-Filled Graphite Electrode

56.76% by weight of Graphite+C65+PTFE (polytetrafluoroethylene) respectively as active material, conducting material and binder, 43.24% by weight of 1 mol/L LiFSI in PYR13FSI+as electrolyte.
Copper current collector=27.5 μm

0.05 g of PTFE is first added to 0.763 g of electrolyte [1 mol/L LiFSI in PYR13FSI], the mixture is then added to the pulverulent mixture of 0.901 g of Graphite and 0.05 g of C65. The resulting mixture is then kneaded and a mechanically stable electrolyte-filled electrode is formed.

The electrolyte-filled anode material is calendered using a calendering machine at different successive controlled thicknesses (e.g. 250 μm-150 μm, etc.) between two 30 μm aluminum sheets each to obtain the desired surface density. For each thickness, 13 mm electrode discs are cut and then placed on the current collector. An anode is formed.

TABLE 10
Characteristics of electrolyte-filled electrodes. The percentage
by weight of electrolyte relative to anode material is 43.24%.

| Calendering machine | Electrode | Electrode mass | Mass of active |
|---|---|---|---|
| adjustment (μm) | thickness (μm) | (mg) | material (mg) |
| 350 | 169.5 | 43.58 | 22.26 |
| 250 | 96.5 | 24.78 | 12.66 |
| 150 | 49.5 | 14.58 | 7.45 |

Table 11 groups the characteristics obtained for Li-ion batteries at 20° C. based on Graphite and comprising the following electrolyte: 1 mol/L LiFSI in PYR13FSI.

TABLE 11
Characteristics of a half-battery with a graphite electrolyte-
filled electrode at different thicknesses at C/20.

| | | Surface | Charge | Discharge |
|---|---|---|---|---|
| Electrode | Mass of active | capacity | capacity | capacity |
| thickness (μm) | material (mg) | (mAh/cm²) | (mAh/g) | (mAh/g) |
| 49.5 | 7.45 | 1.92 | 342.11 | 347.73 |
| 96.5 | 12.66 | 3.37 | 343.04 | 350.90 |

FIG. 14 shows a charge/discharge cycle at C/20 (0.05 C) at 20° C. of two cells each comprising an electrolyte-filled graphite electrode prepared using the method from this disclosure and a lithium metal electrode. For the cell comprising the least thick electrode, specific capacities of 342.11 and 347.73 mAh/g were obtained for charging and discharging when this cell was cycled at C/20. For that comprising the thickest electrode, the specific capacities are 343.04 mAh/g and 350.90 mAh/g for the charge and discharge when the cell cycled at C/10. The specific capacity is maintained at an expected value of ˜350 mAh/g when the thickness of the electrode is doubled and goes from 49.5 to 96.5 μm. These thicknesses correspond to surface capacities of 1.92 and 3.37 mAh/cm².

### Example 11: Electrolyte-Filled Graphite Silicon Electrode

45.93% by weight of silicon-Graphite+C65+PTFE (polytetrafluoroethylene) respectively as active material, conducting material and binder, 54.07% by weight of 1 mol/L LiFSI in EMIFSI+10% wt FEC as electrolyte.
Copper current collector=27.5 μm

0.1 g of PTFE is first added to 1.19 g of electrolyte [1 mol/L LiFSI in EMIFSI+10% wt FEC]; the mixture is then added to the pulverulent mixture of (0.12 g of Silicon and 0.683 g of Graphite) and 0.108 g of C65. The resulting mixture is then kneaded and a mechanically stable electrolyte-filled electrode is formed.

The electrolyte-filled anode material is calendered using a calendering machine at different successive controlled thicknesses (e.g. 200 μm-150 μm, etc.) between two 30 μm aluminum sheets each to obtain the desired surface density. For each thickness, 13 mm electrode discs are cut and then placed on the copper current collector. An anode is formed.

TABLE 12
Characteristics of electrolyte-filled electrodes. The percentage by
weight of the electrolyte relative to the anode material is 54.07%.

| Calendering machine | Electrode | Electrode mass | Mass of active |
|---|---|---|---|
| adjustment (μm) | thickness (μm) | (mg) | material (mg) |
| 200 | 79.5 | 20.28 | 7.51 |
| 150 | 67.5 | 18.58 | 6.78 |

Table 13 groups the characteristics obtained for Li-ion batteries at 20° C. based on Silicon-Graphite and comprising the following electrolyte: 1 mol/L LiFSI in EMIFSI+10% wt FEC.

TABLE 13
Characteristics of a half-battery with an electrolyte-
filled Silicon-Graphite electrode at different at 0.05 C.

| | | Surface | Charge | Discharge |
|---|---|---|---|---|
| Electrode | Mass of active | capacity | capacity | capacity |
| thickness (μm) | material (mg) | (mAh/cm²) | (mAh/g) | (mAh/g) |
| 67.5 | 6.78 | 1.27 | 268.0 | 324.2 |
| 79.5 | 7.51 | 1.69 | 299.4 | 362.0 |

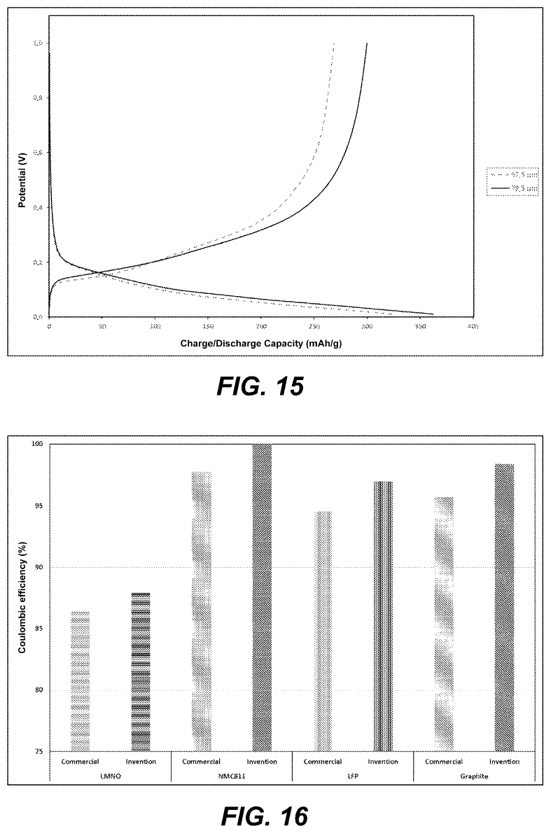

FIG. 15 shows the charge/discharge cycles of the cells; each cell is comprised of an electrolyte-filled silicon-graphite electrode (15% silicon-85% graphite) prepared using the method from this disclosure with two different thicknesses (67.5 μm and 79.5 μm), and a lithium metal electrode, at C/20 and 20° C. These thicknesses correspond to surface capacities of 1.27 and 1.69 mAh/cm². When the thickness of the cathode is 67.5 μm, specific capacities of 268.0 and 324.2 mAh/g were obtained for charging and discharging. When the thickness of the cathode is 79.5 μm, the specific capacities are 299.4 mAh/g and 362.0 mAh/g.

### Example 12: Comparison of Coulombic Efficiencies of the Various Electrode Materials Formulated According to the Method from the Present Disclosure and the Method from the Prior Art

The comparisons are presented in FIG. 16. The coulombic efficiencies of the cells containing an electrode manufactured according to the method from the present disclosure are greater than those containing an electrode produced according to the prior art method for each material.

### Example 13: NaFePO₄-Based Electrode for Sodium-Ion Batteries

56.48% wt NaFePO₄+C65+PTFE (polytetrafluoroethylene) respectively as active material, conducting material and binder, 43.52% by weight of NaFSI: PYR13FSI (ratio 1:9 mol) as electrolyte.
Aluminum current collector=19 μm

0.052 g of PTFE is first added to 0.773 g of electrolyte [NaFSI: PYR13FSI (1:9 mol)]; the mixture is then added to the pulverulent mixture of 0.851 g of NaFePO₄ and 0.100 g of C65. The resulting mixture is then kneaded and a mechanically stable electrolyte-filled electrode is formed.

The electrolyte-filled cathode material is calendered using a calendering machine at different successive controlled thicknesses (e.g. 400 μm-300 μm-200 μm-150 μm, etc.) between two 30 μm aluminum sheets each to obtain the desired surface density. For each thickness, 13 mm electrode discs are cut and then placed on the current collector. A cathode is formed.

TABLE 14
Characteristics of electrolyte-filled electrodes.

| Calendering machine | Electrode | Electrode mass | Mass of active |
|---|---|---|---|
| adjustment (μm) | thickness (μm) | (mg) | material (mg) |
| 400 | 297 | 83.0 | 39.77 |
| 300 | 201 | 65.6 | 26.93 |
| 200 | 143 | 55.6 | 19.31 |
| 150 | 94 | 44.3 | 12.79 |

One of the cathodes of Table 14 weighs 65.6 mg with a NaFePO₄ load of 26.93 mg and has a 201 μm thickness. The percentage by weight of electrolyte relative to the cathode material is 43.52%.

Table 15 groups the estimated characteristics of the Na-ion batteries based on NaFePO4 at 25 and 50° C. and comprising the following electrolyte: NaFSI: PYR13FSI (1:9 mol).

TABLE 15
Estimated characteristics of half-batteries with an electrolyte-
filled Na-ion battery electrode at 0.05 C at 25 or 50° C.

| | Mass of | | Estimated | Estimated |
|---|---|---|---|---|
| Electrode | active | | surface | discharge |
| thickness | material | Temperature | capacity | capacity |
| (μm) | (mg) | (° C.) | (mAh/cm²) | (mAh/g) |
| 143 | 19.31 | 25 | [0.58-1.02] | [40-70] |
| | | 50 | [1.60-1.89] | [110-130] |
| 201 | 26.93 | 25 | [0.81-1.41] | [40-70] |
| | | 50 | [2.23-2.64] | [110-130] |
| 297 | 39.77 | 25 | [1.20-2.09] | [40-70] |
| | | 50 | [3.29-3.90] | [110-130] |

### Example 14: Hard Carbon-Based Electrode for Sodium-Ion Batteries

47.95% by weight of Hard Carbon+C65+PTFE (polytetrafluoroethylene) respectively as active material, conducting material and binder, 52.05% by weight of 0.7 mol/L NaTFSI: PYR14TFSI as electrolyte.
Copper current collector=27.5 μm

0.051 g of PTFE is first added to 1.093 g of electrolyte [0.7 mol/L NaTFSI: PYR14TFSI]; the mixture is then added to the pulverulent mixture of 0.904 g of NaFePO₄ and 0.052 g of C65. The resulting mixture is then kneaded and a mechanically stable electrolyte-filled electrode is formed.

The electrolyte-filled cathode material is calendered using a calendering machine at different successive controlled thicknesses (e.g. 350 μm-250 μm-200 μm, etc.) between two 30 μm aluminum sheets each to obtain the desired surface density. For each thickness, 13 mm electrode discs are cut and then placed on the copper current collector. An anode is formed.

TABLE 16
Characteristics of electrolyte-filled electrodes.

| Calendering machine | Electrode | Electrode mass | Mass of active |
|---|---|---|---|
| adjustment (μm) | thickness (μm) | (mg) | material (mg) |
| 350 | 209 | 45.48 | 19.58 |
| 250 | 160 | 34.18 | 14.72 |
| 200 | 75 | 15.38 | 6.62 |

One of the cathodes of Table 16 weighs 34.18 mg with a 14.72 mg Hard Carbon load and has a 160 μm thickness. The percentage by weight of electrolyte relative to the cathode material is 52.05%.

Table 17 groups the estimated characteristics of the Na-ion batteries based on Hard Carbon at 25, 50 and 90° C. and comprising the following electrolyte: 0.7 mol/L NaTFSI: PYR14TFSI.

TABLE 17
Estimated characteristics of half-batteries with an electrolyte-
filled Na-ion battery electrode at 0.05 C at 25, 50 and 90° C.

| | Mass of | | Estimated | Estimated |
|---|---|---|---|---|
| Electrode | active | | surface | charge |
| thickness | material | Temperature | capacity | capacity |
| (μm) | (mg) | (° C.) | (mAh/cm²) | (mAh/g) |
| 75 | 6.62 | 25 | [0.75-1.25] | [150-250] |
| 160 | 14.72 | 25 | [1.66-2.77] | [150-250] |
| 209 | 19.58 | 25 | [2.21-3.69] | [150-250] |
| 75 | 6.62 | 50 | [1-1.5] | [200-300] |
| 160 | 14.72 | 50 | [2.22-3.33] | [200-300] |
| 209 | 19.58 | 50 | [2.95-4.43] | [200-300] |
| 75 | 6.62 | 90 | [1.15-1.75] | [230-350] |
| 160 | 14.72 | 90 | [2.55-3.88] | [230-350] |
| 209 | 19.58 | 90 | [3.39-5.16] | [230-350] |

1. A method for preparing an electrolyte-filled high charge per unit mass electrode for a high energy-density battery comprising two current collectors separated by an electrolyte composition, a separator and either:
a. two electrodes (an anode, a cathode) physically and electrically contacting the two current collectors, or
b. a cathode in contact only with a current collector respectively, the second current collector being in contact with the separator;
the method comprising the steps of:
i. preparing a mixture A comprising the electrolyte by mixing a metal salt with a solvent;
ii. mixing the mixture A with an active material to obtain a paste;
a binder being added at step a) or b); and
iii. forming the electrode with a predetermined thickness.

2. The method of claim 1, wherein the metal salt comprises (i) a cation selected from lithium, sodium, potassium, calcium, magnesium and zinc, and (ii) an anion selected from hexafluorophosphate (PF6), tetrafluoroborate (BF4), bis(trifluoromethanesulfonyl)imide (TFSI), bis(fluorosulfonyl)imide (FSI), dicyanamide (DCA), 4,5-dicyano-2-(trifluoromethyl)imidazolide (TDI), fluorosulfonyl-(trifluoromethanesulfonyl)imide (FTFSI), (difluoroethanesulfonyl)imide (DFTFSI), bis(oxalato)borate (BOB), difluoro(oxalato)borate (DFOB).

3. The method of claim 1, wherein the solvent is selected from an aprotic organic solvent, a protic organic solvent, or a mixture thereof.

4. The method of claim 3, wherein the aprotic organic solvent is selected from an ionic liquid, propylene carbonate, glyme, or a salt concentrated in aqueous systems in solution.

5. The method of claim 4, wherein the ionic liquid comprises (i) a cation selected from alkylimidazolium, or based on alkylpyrrolidinium, morpholinium, pyridinium, piperidinium, phosphonium, ammonium and (ii) an anion selected from hexafluorophosphate (PF6), tetrafluoroborate (BF4), bis(trifluoromethanesulfonyl)imide (TFSI), bis(fluorosulfonyl)imide (FSI), dicyanamide (DCA), 4,5-dicyano-2-(trifluoromethyl)imidazolide (TDI), fluorosulfonyl-(trifluoromethanesulfonyl)imide (FTFSI), (difluoroethanesulfonyl)imide (DFTFSI), bis(oxalato)borate (BOB), difluoro(oxalato)borate (DFOB).

6. The method of claim 1, wherein the binder is selected from styrene butadiene latex copolymer (SBR), polyacrylonitrile (PAN), polyvinylidene fluoride (PVDF), polyvinylidene fluoride-co-hexafluoropropylene (PVdF-HFP), polyvinylidene fluoride-co-trichlorethylene, polymethyl methacrylate (PMMA), polyvinylpyrrolidone, polyvinyl acetate, polyethylene-co-vinyl acetate, polyethylene oxide, cellulose acetate, cellulose acetate butyrate, cellulose acetate priopionate, cyanoethyl pullulan, cyanoethyl polyvinyl alcohol, cyanoethyl cellulose, cyanoethyl saccharose, pullulan and carboxymethyl cellulose (CMC), polytetrafluoroethylene (PTFE) or a combination of at least two of them, as well as among polymers and their derivatives and/or composites such as polyaniline (PANI), poly(3,4-ethylenedioxythiophene) polystyrene sulfonate (PEDOT:PSS) composites, polyaniline-polyacrylic polymer composites (PANI:PAA) containing a conducting/carboxyl polymer, polypyrrole-carboxymethycellulose PPy/CMC, a hydrogel-based polymer such as (2-acrylamido-2-methyl-1-propanesufonic acid-co-acrylonitrile) (PMAPS), an ionic liquid polymer.

7. The method of claim 1, wherein the material for the cathode is selected from:
a. for a Li-ion battery: a lithium intercalating compound, selected from lithium iron phosphate, (LiFePO₄), lithium nickel-manganese-cobalt oxide, (LiNiₓMn_{y}Co_{z}O₂), doped lithium nickel-manganese-cobalt oxide (LiNiₓMn_{y}Co_{z}O₂), lithium cobalt oxide (LiCoO₂), doped lithium-cobalt oxide, lithium nickel oxide (LiNiO₂), doped lithium nickel oxide, lithium manganese oxide (LiMn₂O₄), doped lithium manganese oxide, lithium vanadium oxide, doped lithium vanadium oxide, lithium mixed metal oxides (LMNO), mixed transition metal oxides, mixed transition metals, doped lithium transition metal oxides, lithium vanadium phosphate, lithium manganese phosphate, lithium cobalt phosphate, mixed lithium and metal phosphates, metal sulfides, and combinations thereof;
b. for Na-ion and K-ion batteries:
i. a metal oxide;
ii. layered NaMOX;
iii. one-dimensional tunnel oxides;
iv. fluorides;
v. sulfates;
vi. phosphates;
vii. pyrophosphates;
viii. fluorophosphates;
ix. mixed phosphates;
x. hexacyanometalates;
xi. cathodes without critical metal;
xii. Prussian white analogs
c. for Zn-ion and Mg-ion batteries:
i. transition metal oxides, MxV2O5 (M=Na, Ca, Zn, Mg, Ag, Li, etc.);
ii. a vanadate;
iii. layered and tunnel type vanadium-based compounds;
iv. polyanionic materials analogous to Prussian blue;
v. metal disulfides,
vi. NASICON compounds
vii. AxMM0 (XO₄)₃ (A: Li, Na, Mg, Zn, etc.; M: Mn, Ti, Fe, etc.; X:P, Si, S, etc.);
viii. organic materials such as quinones
d. for Mg-ion battery: layered sulfide/selenide
e. for Ca-ion battery:
i. 3D tunnel structures such as CaMn₂O₄ spinel,
ii. chevrel phases such as CaMo₆X₈ (X═S, Se, Te),
iii. layered transition metal oxides,
iv. Prussian blue analogs.

8. The method of claim 1, wherein the material for the anode is an active material selected from
a. for a Li-ion battery:
i. a lithium-containing titanium composite oxide (LTO);
ii. metals (Me) such as Si, Sn, Li, Zn, Mg, Cd, Ce, Ni and Fe;
iii graphite, graphene, including particles of natural graphite, artificial graphite, meso-carbon microbeads (MCMB) and carbon (including soft carbon, hard carbon, carbon nanofibers and carbon nanotubes;
iv. silicon (Si), silicon/graphite composites, silicon combinations of germanium (Ge), tin (Sn), lead (Pb), antimony (Sb), bismuth (Bi), zinc (Zn), aluminum (Al), nickel (Ni), cobalt (Co), manganese (Mn), titanium (Ti), iron (Fe), and cadmium (Cd);
v. intermetallic alloys or compounds of Si, Ge, Sn, Pb, Sb, Bi, Zn, Al or Cd with other elements, the alloys or compounds being stoichiometric or non-stoichiometric;
vi. oxides, carbides, nitrides, sulfides, phosphides, selenides, and tellurides of Si, Ge, Sn, Pb, Sb, Bi, Zn, Al, Fe, Ni, Co, Ti, Mn or Cd, and mixtures or composites thereof;
vii. oxides (MeOx) of the metals (Me);
viii. and composites of metals (Me) with carbon;
ix. MXene materials, [MxC where X=2, 3, 4).
b. for Na-ion and K-ion batteries:
i. oxide, sulfides, selenides, phosphides and MOF-based materials and carbon-based materials.
ii. the carbon-based materials comprise expanded graphite, N-doped expanded graphite, carbon black, amorphous carbon, carbon microspheres, hard carbon, meso-powerful soft carbon, carbon nanotubes, graphene nanosheets, nitrogen-doped CNTs, N-doped graphene foam, N-doped porous nanofibers, microporous carbon and cube-shaped porous carbon.
iii. the oxides comprise MnO₂-nanoflowers, NiO nanosheets, porous SnO, porous SnO₂ nanotubes, porous 3D Fe₃O₄—C, porous CuO-RGO, MnO-CNT doped with ultrasmall nitrogen, CuS microflowers, SnS₂-RGO, Co₃S₄-PANI, ZnS-RGO, NiS-RGO, Co₃S₄-PANI, MoS₂-C, conductive WS2-carbon nanosheets doped with nitrogen, Sb₃Se₃-RGO nanorods, MoSez-carbon fiber, the multishell Sn₄P₃ nanostructures, Sn₄P₃-C nanospheres, Se₄P₄, CoP nanoparticles, FeP nanorods matrices on carbon cloth, MoP-C, CUP₂-C, hollow NiO/Ni graphene, CoSe/C structured in shell-yellow doped with nitrogen
iv. Na metal
c. for Mg-ion and Zn-ion batteries: graphite, polynano crystalline graphite, expanded graphite, hard carbon/carbon black, hard-soft composite carbon, hard carbon microspheres, activated charcoal, a multi-layer F-doped graphene, nitrogen-doped carbon microsphere, hierarchically porous N-doped carbon, phosphorous and oxygen dual-doped graphene, nitrogen- and oxygen-doped carbon nanofiber, tire rubber derived hard carbon, porous carbon nanofiber paper, polycristalline soft carbon, nitrogen-doped natural carbon nanofibers, nitrogen/oxygen double-doped hard carbon, K₂Ti₄O₉ and K₂Ti₄O₉.
d. for Zn-ion batteries:
i. zinc metal, zinc alloys
ii. graphite and carbonaceous materials
e. for Ca-ion battery:
i. calcium-metal alloys
ii. tin metal
iii. graphite and carbonaceous materials.

9. The method of claim 1, wherein a conducting material is added in step b) before the mixing.

10. The method of claim 1, wherein the electrolyte comprises an additive.

11. The method of claim 9, wherein the conducting material is selected from carbon black consisting of acetylene black, carbon black, ketjen black, canal black, furnace black, lamp black or thermal black; graphite; a conducting material comprising conducting fibers; a metal powder; conducting metal monocrystalline filaments; titanium dioxide; or a polyphenylene derivative.

12. The method of claim 1, wherein step c) of forming the electrode is selected from the following techniques: a paste rolling technique, a 3D printing technique for paste, an extrusion technique or a jet milling technique.

13. The method of claim 1, wherein a percentage by mass of electrolyte: active material is in the range [15: 85].

14. An apparatus for implementing the method according to claim 1.

15. An electrolyte-filled high charge per unit mass electrode for a high energy-density battery obtained by the method according to claim 1.

16. A high energy-density battery comprising at least one electrolyte-filled electrode prepared in accordance with a method according to claim 1, a separator and two current collectors, wherein:
a. when the battery comprises two electrodes, the current collectors are respectively connected to the electrodes (i.e. cathode, anode), and the electrodes consist of:
i. an anode electrode prepared in accordance with the method according to claim 1, and a cathode electrode, or
ii. a cathode electrode prepared in accordance with the method according to claim 1, and an anode electrode, or
iii. a cathode electrode and an anode electrode both prepared in accordance with the method according to claim 1, or
b. when the battery comprises a cathode electrode only, the current collectors are respectively connected to the cathode and to the separator, where the cathode electrode is prepared in accordance with the method according to claim 1.

17. A high energy-density battery according to claim 16, wherein the cathode electrolyte is different from the anode electrolyte.

18. The method of claim 13, wherein the percentage by mass of electrolyte: active material is in the range [30: 75].

19. The method of claim 18, wherein the percentage by mass of electrolyte: active material is in the range [40: 60].

20. The method of claim 2, wherein the solvent is selected from an aprotic organic solvent, a protic organic solvent, or a mixture thereof.
